(19) United States
(12) Patent Application Publication
(10) Pub. No.: US 2003/0211307 A1
(43) Pub. Date: Nov. 13, 2003

(54) Low-density injection-molded body components

(76) Inventor: Marshall Ray Porter, Oakdale, IL (US)

Correspondence Address: BANNER & WITCOFF, LTD., TEN SOUTH WACKER DRIVE, SUITE 3000, CHICAGO, IL, 60606, US

(21) Appl. No.: 10/204,611

(22) PCT Filed: Feb. 23, 2001
(86) PCT No.: PCT/US01/05851

(51) Int. Cl. B32B 3/12

(52) U.S. Cl. 428/313.3; 428/313.5; 428/313.7; 428/317.9; 428/71; 428/319.3

(57) ABSTRACT

The present invention provides a co-injection molded, multiphase vehicle component having a microsphere enhanced region, as well as a method for constructing such a vehicle component. The vehicle component has an outer portion or phase that is formed by first injecting a preselected quantity of a desired thermoplastic material into a preselected mold (402) in a manner to achieve a first layer of the thermoplastic material in a cavity of the mold. Then, a microsphere enhanced inner portion or phase is formed by injection of a micrsophere enhanced core material (404) to fill a remaining portion of the cavity. The resulting vehicle component typically has a lower density, and thus a lower weight, is generally less costly, and maintains the desired strength by selection of suitable microspheres, typically substantially hollow, and a suitable proportion of microspheres per unit volume of core material.

### RELATED APPLICATIONS

Priority is claimed to provisional application Serial No. 60/184,743, entitled “Injection Molding Techniques Utilizing Fluid Channels,” No. 60/184,639, entitled “Integrated Co-Injection Molded Bumpers and Methods of Making the Same,” and No. 60/184,564, entitled “Low-Density Injection-Molded Body Parts,” which were all filed on Feb. 24, 2000, and Serial No. 60/264,916, entitled “Multi-Part Sequential Valve Gating,” which was filed Jan. 29, 2001.

### FIELD OF THE INVENTION

The present invention is related to co-injection molding and in particular, to sequential co-injection molding of low-density vehicle components.

### BACKGROUND OF THE INVENTION

Injection molding typically includes injecting a thermoplastic material into a mold. As the material contacts the mold wall, it solidifies quickly while the center or core remains molten until enough time has elapsed for it to solidify. In co-injection, a second material is injected while the core is still molten. As a result, the molten core material is displaced by the second material. The finished part has an outside layer which is the same material first injected and a middle layer or core comprising the second material. For appearance reasons, thermoplastic materials often contain expensive additives to give the product color and other additives to make it resistant to deterioration from ultraviolet radiation. Since the core material is usually enclosed, a lower cost material can be used with scrap material from the primary process.

However, there are additional opportunities to use this technology to reduce the weight or cost of the product or solve sink issues in thick sections.

### SUMMARY OF THE INVENTION

The present invention provides a co-injection molded, multiphase vehicle component with a microsphere enhanced region wherein the component incorporates microspheres with the core material to reduce the density of the core, reduce the weight of the component and lower the cost by displacing a more expensive core material, while maintaining the surface appearance and strength of the component. In addition, it reduces shrinkage in thick sections to eliminate sinks in appearance areas. The present invention further provides a method for manufacturing such a component.

The present invention provides a co-injection molded, multiphase vehicle component with a microsphere enhanced region that has an outer portion or phase (also known as a “skin”) formed by injection of a preselected quantity of a desired thermoplastic material into a preselected mold in a manner to achieve a first layer of the thermoplastic material in a cavity of the mold. The component also includes a microsphere enhanced inner portion or phase formed by injection of a microsphere enhanced core material to fill a remaining portion of the cavity. The microspheres are used to displace a more expensive core filling material, thus also providing a less dense core, reducing the weight of the component while maintaining its strength. The microspheres utilized may be substantially hollow, substantially solid, or a mixture of both. Clearly, using substantially hollow microspheres material results in a component with a less dense core and a minimized weight.

### BRIEF DESCRIPTION OF THE DRAWINGS

FIGS. 1A and 1B illustrate a beginning of a first injection process and a second injection process, respectively, of the co-injection process in accordance with the present invention.

FIG. 2 illustrates a rear bumper perspective view and section view in accordance with the prior art.

FIG. 3 illustrates a bumper similar to the bumper of FIG. 2, except that the bumper was manufactured as a co-injection molded, multiphase vehicle component in accordance with the present invention.

FIG. 4 is a flow chart showing one embodiment of steps of a method in accordance with the present invention.

### DETAILED DESCRIPTION OF THE PREFERRED EMBODIMENTS

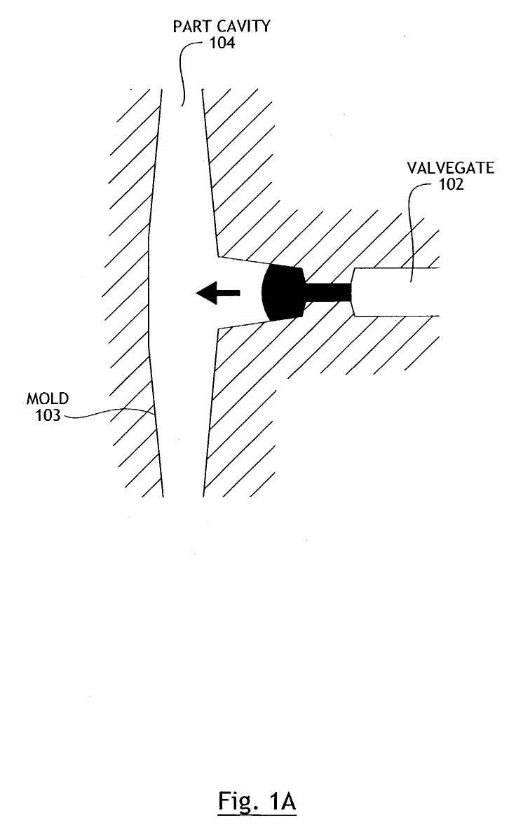

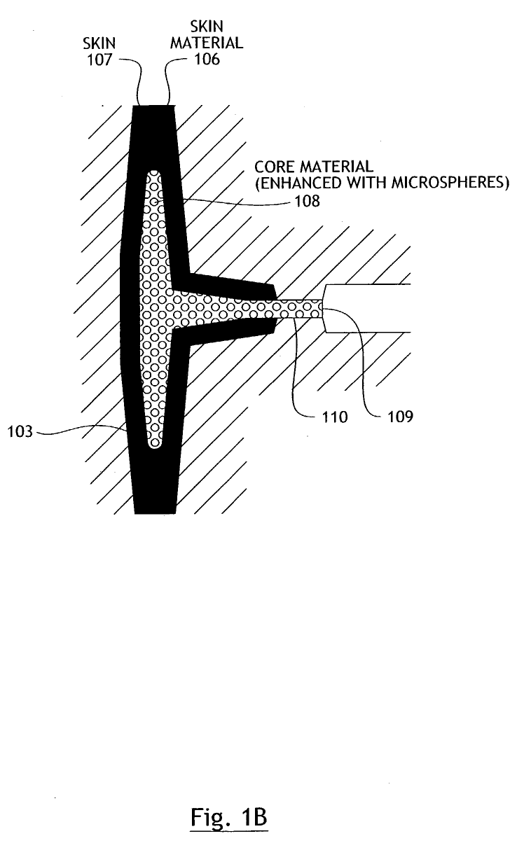

The co-injection molded, multiphase vehicle component includes an outer portion or phase formed by injection of a preselected thermoplastic material into a preselected mold and a microsphere enhanced inner portion or phase formed by injection of a microsphere enhanced core material. The co-injection is an iterative process performed by injecting the preselected thermoplastic material 106 into a first mold or part cavity, as illustrated in FIG. 1A, in a manner to achieve a first layer or skin 107 of the thermoplastic material 106 in cavity 104 of the mold and permitting the preselected thermoplastic material 106 to form the first layer 107. The microspheres can comprise reinforcing fibers, such as glass, ceramic, carbon and/or rigid organic polymers, or reinforcing particles, such as metals or nanoparticles (for example, nanoparticles comprising smectite clay).

As illustrated in FIG. 1B, after the first layer 107 has been formed, a desired core material 108 that has been enhanced by addition of a preselected volume of microspheres is injected to fill a remaining portion of the mold cavity 104. Where desired, for example, core material may represent ten percent to sixty percent of a cut cross-section of a molded component. Selection of the volume of microspheres to be utilized depends on the desired resultant density and strength of the microsphere enhanced core material. The size of the microspheres is constrained to a size that permits continuance of core thermoplastic material. That is, the diameters of the microspheres are no more than the diameter of the bore of the nozzle 109 inputting the core material 108 and the opening 110 of the mold receiving the core material 108 that has been enhanced by the addition of the microspheres.

Microspheres utilized in the core material may, for example, be tiny glass balls suitable for being processed by an injection-molding machine. For example, microspheres having a diameter between about 1 and 350 μm may be utilized. Where solid microspheres are desired, the microspheres may, for example, consist of glass, carbon, rigid organic polymers, or ceramic. Alternatively, in a preferred embodiment, hollow microspheres may be utilized, thereby further reducing the density of the core. The hollow microspheres do not have to be spherical in shape, but may be any shape that may be processed by an injection-molding machine, wherein, in a preferred embodiment, the microsphere structure is typically substantially hollow and displaces core material. For example, glass microspheres may be prepared by grinding glass to form particles smaller than 1 to 350 μm, then passing the particles through a gas flame that softens the glass and expands the microspheres. Such hollow microspheres may not perfectly spherical, but function to reduce the density of the injected core material and minimize costs by displacing the typically more expensive core material. Also clearly, after the microspheres are exposed to the heating/expansion process, the microspheres may contain some substantially hollow microspheres and some substantially solid microspheres. Thus, the microspheres utilized may be substantially hollow, substantially solid or a mixture of substantially hollow and substantially solid microspheres. Ceramics such as aluminosilicates may be utilizes to provide either solid or hollow microspheres. Microspheres are available commercially, e.g., from the 3M® Company.

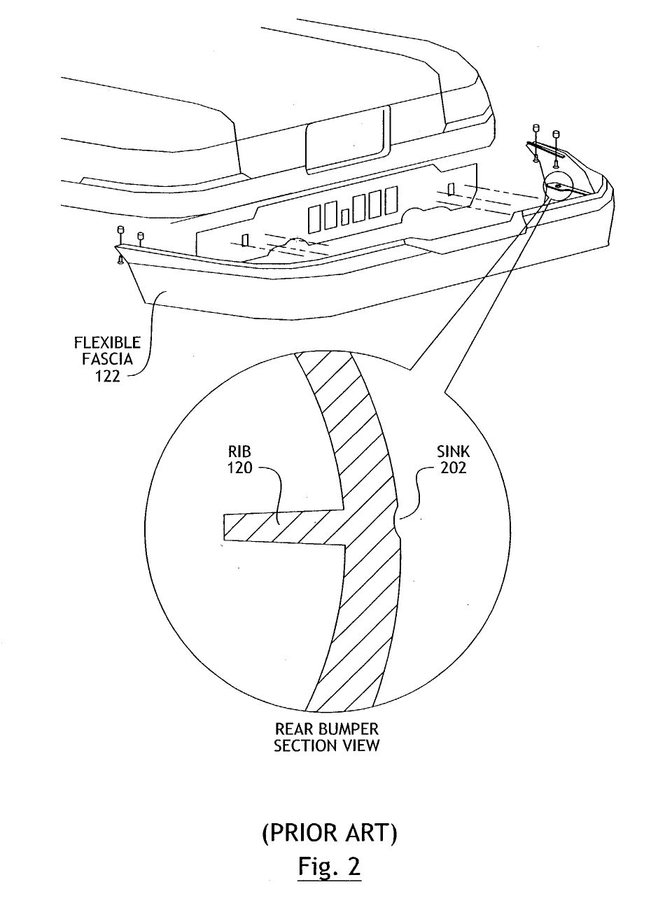

FIG. 2 illustrates a rear bumper perspective view and section view in accordance with the prior art. As rib(s) 120 are currently being manufactured, the ribs 120 which are utilized to provide strength to flexible fascia or bumper 122 also typically cause a sink mark 202 to appear on the front of the bumper opposite the rib 120.

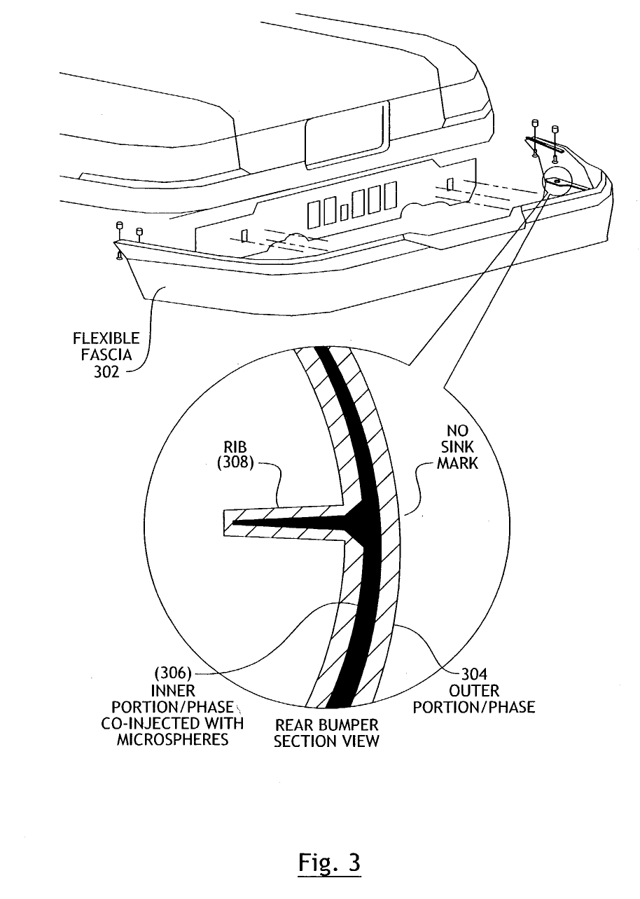

FIG. 3 illustrates a bumper similar to the bumper of FIG. 2, except that the flexible fascia or bumper 302 is manufactured as a co-injection molded, multiphase vehicle component in accordance with the present invention. The flexible fascia 302 is molded such that the preselected region is molded to achieve an outer portion or phase 304 of thermoplastic material and an inner portion or phase 306 that is co-injected with microspheres, as described more fully below. Ribs 308 may be formed in this manner, providing additional strength without causing sink marks on the surface of flexible fascia 302 opposing the rib 308.

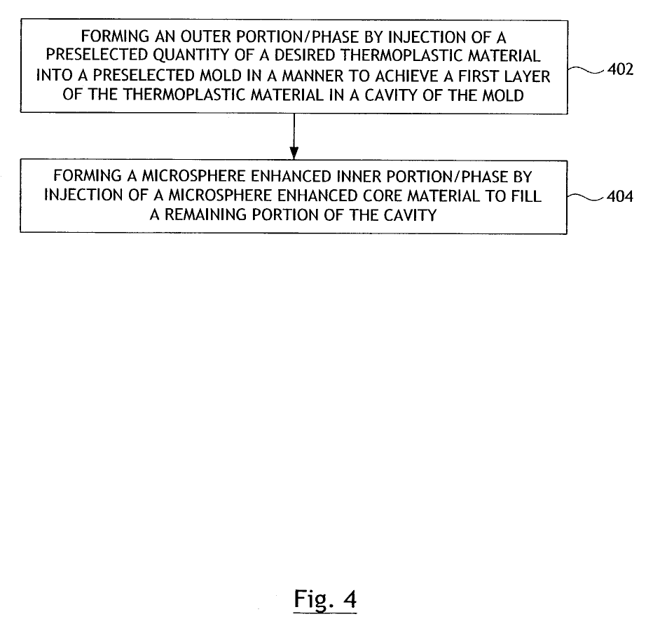

FIG. 4 is a flow chart showing one embodiment of steps of a method in accordance with the present invention. The method of the present invention provides for molding a multiphase vehicle component with a microsphere enhanced region using co-injection comprising step 402 of forming an outer portion or phase 304 by injection of a preselected quantity of a desired thermoplastic material into a preselected mold in a manner to achieve a first layer of the thermoplastic material in a cavity of the mold; and step 404 of forming a microsphere enhanced inner portion or phase 306 by injection of a microsphere enhanced core material to fill a remaining portion of the cavity. Step 402 of forming an outer portion or phase 304 by injection of a preselected quantity of a desired thermoplastic material into a preselected mold in a manner to achieve a first layer of the thermoplastic material in a cavity of the mold is known to those skilled in the art.

Initiation of the formation of the outer portion/phase is also shown in FIG. 1A. A valve gate 102 in the mold is utilized to inject the thermoplastic material which forms the outer portion/layer, which may be referred to as a “skin”, into a part cavity 104. An illustration of step 404 of forming a microsphere enhanced inner portion/phase by injection of a microsphere enhanced core material to fill a remaining portion of the cavity is also shown in FIG. 1B. The “skin” material 106 lines the mold, and the inner portion/phase/core is formed by injecting the core material that is enhanced with microspheres 108 as described more fully above to fill the remaining portion of the cavity 104 of the mold 103.

Typically, the co-injection molded, multiphase vehicle component is a vehicle body panel, a side air dam, a vehicle fender, a fascia or a bumper. Generally, the vehicle body panel is a door panel or a side panel.

It should be understood that the foregoing description is only illustrative of the invention. Various alternatives, equivalents and modifications can be devised by those skilled in the art without departing from the invention. Accordingly, the present invention is intended to embrace all such alternatives, equivalents, modifications and variances that fall within the scope of the appended claims.

What is claimed is:

1. A co-injection molded, multiphase vehicle component with a microsphere enhanced region, comprising:
an outer portion formed by injection of a preselected quantity of a desired thermoplastic material into a preselected mold in a manner to achieve a first layer of the thermoplastic material in a cavity of the mold; and
a microsphere enhanced inner portion formed by injection of a microsphere enhanced core material to fill a remaining portion of the cavity.

2. The co-injection molded, multiphase vehicle component of claim 1 wherein the microspheres in the microsphere enhanced core material are substantially hollow.

3. The co-injection molded, multiphase vehicle component of claim 2 wherein the microspheres comprise at least one of: glass, ceramic, carbon, and rigid organic polymers.

4. The co-injection molded, multiphase vehicle component of claim 1 wherein the microspheres in the microsphere enhanced core material are substantially solid.

5. The co-injection molded, multiphase vehicle component of claim 4 wherein the microspheres comprise at least one of: glass, ceramic, carbon, and rigid organic polymers.

6. The co-injection molded, multiphase vehicle component of claim 1 wherein the microspheres in the microsphere enhanced core material include microspheres that are substantially hollow and microspheres that are substantially solid.

7. The co-injection molded, multiphase vehicle component of claim 6 wherein the microspheres comprise at least one of: glass, ceramic, carbon, and rigid organic polymers.

8. The co-injection molded, multiphase vehicle component of claim 1 wherein the component is one of: a vehicle body panel, a side air dam, a vehicle fender, a fascia and a bumper.

9. The co-injection molded, multiphase vehicle component of claim 1 wherein the vehicle body panel is one of: a door panel and a side panel.

10. A method for molding a multiphase vehicle component with a microsphere enhanced region using co-injection, comprising the steps of:
forming an outer portion by injection of a preselected quantity of a desired thermoplastic material into a preselected mold in a manner to achieve a first layer of the thermoplastic material in a cavity of the mold; and
forming a microsphere enhanced inner portion by injection of a microsphere enhanced core material to fill a remaining portion of the cavity.

11. The method of claim 10 wherein the microspheres in the microsphere enhanced core material are substantially hollow.

12. The method of claim 11 wherein the microspheres comprise reinforcing material.

13. The method of claim 10 wherein the microspheres in the microsphere enhanced core material are substantially solid.

14. The method of claim 13 wherein the microspheres comprise reinforcing material.

15. The method of claim 10 wherein the microspheres in the microsphere enhanced core material include microspheres that are substantially hollow and microspheres that are substantially solid.

16. The method of claim 15 wherein the microspheres comprise reinforcing material.

17. The method of claim 10 wherein the component is one of: a vehicle body panel, a side air dam, a vehicle fender, a fascia and a bumper.

18. The method of claim 17 wherein the vehicle body panel is one of: a door panel and a side panel.

19. The method of claim 12, 14 or 16 wherein the reinforcing material is selected from the group consisting of glass fibers, ceramic fibers, carbon fibers, organic polymers, and nanoparticles.
